(19) United States
(12) Patent Application Publication
(10) Pub. No.: US 2024/0176614 A1
(43) Pub. Date: May 30, 2024

(54) AUTOMATION OF GENERATING ROBOTIC PROCESS AUTOMATION FROM AUTOMATION DOMAIN SPECIFIC LANGUAGES

(71) Applicant: INTERNATIONAL BUSINESS MACHINES CORPORATION, Armonk, NY (US)

(72) Inventors: Zachary A. SILVERSTEIN, Georgetown, TX (US); Suman PATRA, KOLKATA (IN); Melanie DAUBER, Oceanside, NY (US); Jeremy R. FOX, Georgetown, TX (US)

(21) Appl. No.: 18/072,533

(22) Filed: Nov. 30, 2022

(51) Int. Cl. G06F 8/71; G06F 8/10; G06F 8/60

(52) U.S. Cl. CPC G06F 8/71; G06F 8/10; G06F 8/60

(57) ABSTRACT

Aspects of the present disclosure relate generally to robotic process automation (RPA) and, more particularly, to systems, computer program products, and methods of automation of generating RPA robots (bots) from automation domain specific languages (DSL). For example, a computer-implemented method includes receiving, by a processor set, process automation requirements specifying a process flow; generating, by the processor set, alternative automation requirements in a domain specific language from terms of the domain specific language identified in the process automation requirements; generating, by the processor set, robotic process automation code from the alternative automation requirements in the domain specific language; building, by the processor set, a robotic process automation robot deployable in a production environment using the robotic process automation code; and deploying, by the processor set, the robotic process automation robot in the production environment.

### BACKGROUND

Aspects of the present invention relate generally to robotic process automation (RPA) and, more particularly, to systems, computer program products, and methods of automation of generating RPA robots (bots) from automation domain specific languages (DSL).

Deployment of robotic process automation projects have accelerated across many organizations to perform a variety of tasks done manually. Business teams typically produce and deliver process documents used by RPA developers to design and implement automation of desired process flows or modify existing ones. However, validation of the business process documentation can be tedious and time consuming, since the process documents can contain numerous ambiguities, unique terms or obscurities. It remains a challenge for RPA developers to interpret the requirements in the process documents and generate RPA code that meets the intended requirements.

RPA code is typically expressed in human-readable language of one or more keywords and a command or programmed actions that perform steps of a specified requirement in the process documents. In the development process, RPA code written as keywords and programmed actions may be stored in a repository such as one of several libraries used in an integrated development environment. In order to reuse existing RPA code developed for performing a specific task, the RPA developer needs to find the code that meets the requirements for performing the specific task. Locating such reusable RPA code can be a haphazard experience given limited integrated development interface (IDE) tools available to do so, such as using an autocomplete text feature for inputting keywords to locate the RPA code in known repositories. There are many repositories with reusable RPA code that such limited features are unable to discover resulting in limited reuse of existing RPA code.

When an RPA developer can locate reusable RPA code that meets a requirement for performing a task specified in the requirements document, the RPA developer may need to complete arguments to commands, such as specifying the address of a database or other resource used in steps of the process flow. As RPA automations continue to proliferate, it becomes increasingly critical for existing RPA code to be easily discovered and reused in RPA automation projects.

### SUMMARY

In a first aspect of the invention, there is a computer-implemented method provided. The computer-implemented method receives process automation requirements specifying a process flow and generates alternative automation requirements in a domain specific language from terms of the domain specific language identified in the process automation requirements. The computer-implemented method also generates robotic process automation code from the alternative automation requirements in the domain specific language. The computer-implemented method further builds a robotic process automation robot deployable in a production environment using the robotic process automation code and deploys the robotic process automation robot in the production environment. Advantageously, the computer-implemented method of the present invention converts process automation requirements into structured unambiguous automation steps of DSL requirements that remediate ambiguities in process automation documents. Furthermore, the computer-implemented method advantageously facilitates automation of generating an RPA bot.

In permissive aspects of the computer-implemented method, supplemental terminology selected from the group consisting of an alternative reference, search names, and an association to commands is appended to keywords from the process automation requirements. Additionally, the computer-implemented method identifies requirements in the process automation requirements with actions based on satisfying conditions using an artificial intelligence model trained to identify conditions in the process automation requirements by comparing features extracted from text in the process automation requirements with features of conditions extracted from text in a corpus of training data from robotic process automation projects. These permissive aspects of the computer-implemented method of the present invention advantageously convert varying process automation requirements into structured unambiguous automation steps of DSL requirements that remediate ambiguities in process automation documents.

In another aspect of the invention, there is provided a computer program product including one or more computer readable storage media having program instructions collectively stored on the one or more computer readable storage media. The program instructions are executable to receive process automation requirements specifying a process flow and generate alternative automation requirements in a domain specific language from terms of the domain specific language identified in the process automation requirements. The computer program product has further program instructions to generate robotic process automation code from the alternative automation requirements in the domain specific language using a machine learning model trained with features of a plurality of robotic process automation code associated with features of a plurality of process automation requirements from training data of robotic process automation projects. The computer program product has additional program instructions to build a robotic process automation robot deployable in a production environment using the robotic process automation code and deploy the robotic process automation robot in the production environment. Permissive program instructions of the computer program product are further executable to identify the terms of the domain specific language from the process automation requirements using an artificial intelligence model trained to identify the terms of the domain specific language from a corpus of training data of robotic process automation projects. Advantageously, the program instructions of the computer program product of the present invention to generate RPA code for the steps of the DSL requirements using the machine learning model facilitates automation of generating an RPA bot and reuse of existing RPA code that meets automation requirements.

In another aspect of the invention, there is system including a processor set, one or more computer readable storage media, and program instructions collectively stored on the one or more computer readable storage media. The program instructions are executable to receive process automation requirements specifying a process flow and generate alternative automation requirements in a domain specific language from terms of the domain specific language identified in the process automation requirements using an artificial intelligence model trained to identify the terms of the domain specific language from a corpus of training data of robotic process automation projects. The program instructions are further executable to generate robotic process automation code from the alternative automation requirements in the domain specific language and build a robotic process automation robot deployable in a production environment using the robotic process automation code. Permissive program instructions are further executable to identify the robotic process automation code from the alternative automation requirements in the domain specific language using a machine learning model employing a Long Short Term Memory (LSTM) algorithm trained with features of a plurality of process automation requirements and a plurality of robotic process automation code associated with the features of the plurality of process automation requirements from training data of robotic process automation projects. Advantageously, the program instructions of the system of the present invention converts process automation requirements into structured unambiguous automation steps of DSL requirements that remediates ambiguities in process automation documents. Further, the system advantageously generates RPA code for the steps of the DSL requirements to facilitate automation of generating an RPA bot and reuse of existing RPA code that meets DSL requirements.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the invention.

FIG. 3 depicts an illustration of an exemplary process flow in accordance with aspects of the invention.

FIG. 4 shows a flowchart of an exemplary method in accordance with aspects of the invention.

FIG. 5 shows a flowchart of an exemplary method in accordance with aspects of the invention.

FIG. 6 shows a flowchart of an exemplary method in accordance with aspects of the invention.

### DETAILED DESCRIPTION

Aspects of the present invention relate generally to RPA and, more particularly, to systems, computer program products, and methods of automation of generating RPA bots from automation DSLs. More specifically, aspects of the invention relate to methods, computer program products, and systems for automation of generating RPA bots from automation DSLs that may assist an RPA developer in generating an initial version of the RPA bot from process requirement documents. Embodiments of the present disclosure recognize the need for improvements in generating RPA bots from process automation requirements, producing process automation requirements in structured unambiguous automation steps, and facilitating prevalent reuse of RPA code. In embodiments of the present disclosure, an AI module uses a historical corpus of various information from RPA projects to convert process automation requirements into structured unambiguous automation steps of DSL requirements that remediates ambiguities in process automation documents. Automation generator modules employing a machine learning model generate RPA code for the steps of the DSL requirements to facilitate automation of generating an RPA bot and reuse of existing RPA code that meets DSL requirements.

In general, the system of the present invention analyzes historical data in embodiments from the RPA developer pulled from journals, logbooks and delivered codebases and creates a training dataset based on the keywords in input requirements and the programmed actions. The system further performs logical analysis of RPA codes and creates DSL conditional operators. The AI model is trained using the training dataset to identify DSL terms and generate DSL conditional operators for translation into DSL requirements. The system creates a translator that takes the output of the AI model and creates alternative requirements in DSL format. Generators implement the alternative requirements by interpreting the requirement and emitting code specific to their technology. For instance, the generator reads the DSL, interprets the keywords into the interface format, and generates RPA code for the requirement.

Furthermore, the user of the system may be offered the option in embodiments of substituting a different term in the system, for instance using a synonym for the word. In embodiments, an interface may ask the user for a definition that is potentially shared with other users of the application and displayed in a pop-up window. Such an interface could use machine learning to learn from the user's choice and repeat the same pattern for future automations, or default to the user's preference. In order to ensure continuous improvement, the generated DSL and RPA code can both be validated by the RPA developer and RPA experts.

In embodiments, the methods, systems, and program products described herein receive process automation requirements, identify DSL terms, and generate DSL conditional operators for translation of process automation requirements into DSL requirements using the AI model. The AI model is trained in embodiments using a training dataset based on keywords and programmed actions from the historical information to identify DSL terms and generate DSL conditional operators for translation into DSL requirements. The historical information includes a corpus of requirements documents, working documents such as journals and logbooks, delivered codebases, and various automation DSL requirements pulled from earlier or similar automation projects.

The methods, systems, and program products described herein generate RPA code for the DSL requirement using a machine learning model trained using the training dataset to generate RPA code for the DSL requirements. In embodiments, the machine learning model employs a Long Short Term Memory (LSTM) algorithm trained with features of process automation requirements and RPA code associated with the features of the process automation requirements from the training dataset to identify RPA code that meets the DSL requirement. The RPA developer can validate the automation DSL requirements and RPA code and also provide feedback that can be used to improve the RPA code and improve the training dataset, the AI model, and the machine learning model. The validated RPA code can be built into a deployable image of the automation and the automation can be deployed in the production environment.

Aspects of the present invention are directed to improvements in computer-related technology and existing technological processes for automation of generating RPA bots. In embodiments, the system including a processor set, a computer readable memory, one or more computer readable storage media, and program instructions collectively stored on the one or more computer readable storage media, may receive process automation requirements specifying a process flow and generate alternative automation requirements in a domain specific language from terms of the domain specific language identified in the process automation requirements using an artificial intelligence model trained to identify the terms of the domain specific language from a corpus of training data of robotic process automation projects. Advantageously, process automation requirements are converted into structured unambiguous automation steps of DSL requirements that remediates ambiguities in process automation documents. The system further generates robotic process automation code from the alternative automation requirements in the domain specific language and builds a robotic process automation robot deployable in a production environment using the robotic process automation code. Advantageously, the system generates RPA code for the steps of the DSL requirements to facilitate automation of generating an RPA bot and reuse of existing RPA code that meets DSL requirements. These are specific improvements in the way computers may operate and interoperate to automatically generate RPA bots from automation DSLs to assist an RPA developer in generating an initial version of the RPA bot from process requirement documents.

Implementations of the disclosure describe additional elements that are specific improvements in the way computers may operate and these additional elements provide non-abstract improvements to computer functionality and capabilities. As an example, a computer program product including one or more computer readable storage media having program instructions collectively stored on the one or more computer readable storage media may receive process automation requirements specifying a process flow and generate alternative automation requirements in a domain specific language from terms of the domain specific language identified in the process automation requirements. The computer program product has further program instructions to generate robotic process automation code from the alternative automation requirements in the domain specific language using a machine learning model trained with features of a plurality of robotic process automation code associated with features of a plurality of process automation requirements from training data of robotic process automation projects. Advantageously, generating RPA code for the steps of the DSL requirements using the machine learning model facilitates automation of generating an RPA bot and reuse of existing RPA code that meets automation requirements. The computer program product has additional program instructions to build a robotic process automation robot deployable in a production environment using the robotic process automation code and deploy the robotic process automation robot in the production environment. The additional elements are specific improvements in the way computers may operate to automate generation of RPA bots, and these additional elements provide non-abstract improvements to computer functionality capabilities.

It should be understood that, to the extent implementations of the invention collect, store, or employ personal information provided by, or obtained from, individuals, such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as automation of generating a robotic process automation bot from an automation domain specific language 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

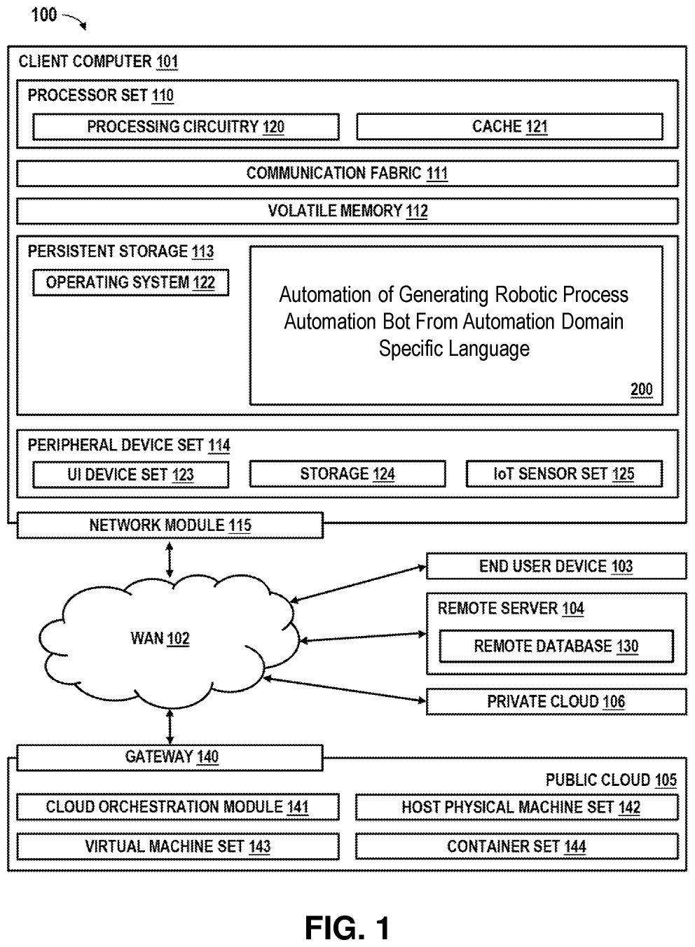

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

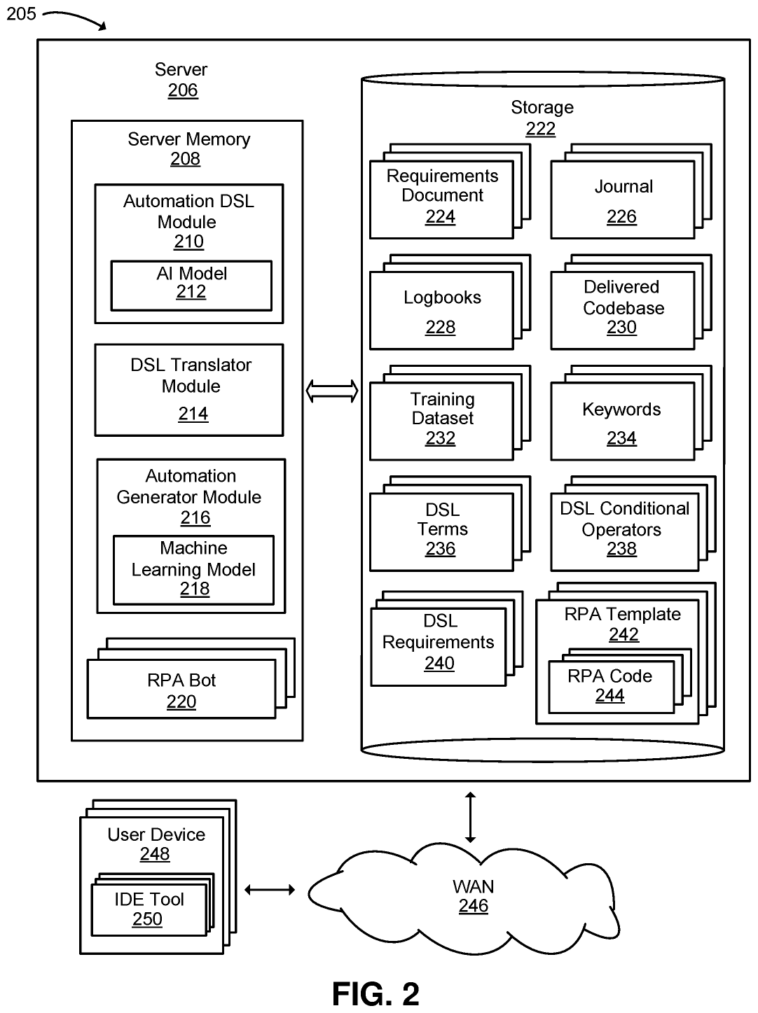

FIG. 2 shows a block diagram of an exemplary environment 205 in accordance with aspects of the invention. In embodiments, the environment includes a server 206, which may be a computer system such as a computer 101 described with respect to FIG. 1 with which end user devices 103 and remote servers 104, each also described with respect to FIG. 1, may communicate over a network such as WAN 102 described with respect to FIG. 1. In general, server 206 supports services for automation of generating RPA bots from automation DSLs.

Server 206 has a server memory 208 such as volatile memory 112 described with respect to FIG. 1. Server 206 includes, in memory 208, an automation DSL module 210 having functionality to receive data, including specifications of process automation requirements documenting a process flow, such as a process definition document (PDD), and working documents for creating a RPA bot such as a developer's journal or logbook, and the delivered codebase of previous versions of RPA bots for automation of process automation requirements, among other data provided and used for development of the RPA bot, and process this data to generate automation DSL requirements. The automation DSL module 210 may include an Artificial Intelligence (AI) model 212 trained to identify keywords for actions to be performed by the RPA bot, identify DSL terms and generate DSL conditional operators for translation into DSL requirements from the data received by the automation DSL module 210. In identifying keywords, the AI model 212 may also identify alternative or supplemental terminology for keywords in commands of the DSL used in the development of previous versions of RPA bots. Such alternative or supplemental terminology of the keywords identified by the AI model 212 may include an alternative reference, search names or association to given commands. The AI model 212 may augment the identified keywords in commands of the DSL to include the alternative or supplemental terminology of the keywords identified by the AI model 212.

Additionally, server 206 includes a DSL translator module 214 having functionality to translate keywords identified in process definition requirements from specifications and working documents, identified DSL terms, and DSL conditional operators into structured unambiguous automation steps of a DSL, among other functionality. Server 206 also includes, in memory 208, one or more automation generator modules 216 having functionality to receive automation DSL requirements and emit RPA code that populates an RPA template or script for generation of the RPA bot. The automation generator module 216 may include a machine learning model 218 that receives a DSL requirement as input, interprets a keyword in the DSL requirement for insertion into the RPA template or script and for generating the command or programming action for the DSL requirement, generates RPA code for the DSL requirement that includes the keyword and command or programming action that fulfills the DSL requirement, and inserts the RPA code into the RPA template or script. Server 206 may additionally include, in memory 208, one or more RPA bots 220 generated from the RPA template or script populated with emitted RPA code.

In embodiments, server 206 of FIG. 2 comprises automation DSL module 210, DSL translator module 214, and automation generator module 216, each of which may comprise modules of the code of block 200 of FIG. 1. These modules of the code of block 200 are executable by the processing circuitry 120 of FIG. 1 to perform the inventive methods as described herein. Server 206 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, FIG. 2 also shows a block diagram of storage 222 which may be storage such as storage 124 of computer 101 described with respect to FIG. 1. Storage 222 may store one or more requirements documents 224 that can be any type of specification of process automation requirements documenting a process flow, such as a process definition document (PDD), a Business Process Modeling Notation (BPMN) diagram, or other type of specification including an audio file of spoken process automation requirements. Storage 222 may also store various working documents for creating an RPA bot such as a developer's journal 226 or logbook 228 that associates process automation requirements with keywords and commands or programmed action or identified libraries that include various keywords and programmed actions that may fulfill some process automation requirements. Storage 222 may additionally store one or more delivered codebases 230 of previous versions of RPA bots, including templates or scripts, for automation of earlier automation projects that, for example, may be similar or may include similar process automation requirements.

Storage 222 may store training dataset 232 in files for training AI model 212 to identify DSL terms and generate DSL conditional operators for translation into DSL requirements and for training machine learning model 218 to generates RPA code that fulfills the DSL requirements and inserts the RPA code into the RPA template or script. For example, the training dataset may include a corpus of requirements documents 224, journals 226, logbooks 228, delivered codebases 230, and various automation DSL requirements from earlier or similar automation projects.

Storage 222 may also store keywords 234 in files, DSL terms 236 in files, and DSL conditional operators 238 in files identified by the AI model 212 for generating automation DSL requirements 240 in files from automation requirements documents for current and earlier automation projects. The DSL terms 236 may include identified keywords from the requirements documents 224 augmented with alternative or supplemental terminology of keywords that include an alternative reference, search names or an association to given commands. For instance, the keyword “Notify” in a requirements document specifying “Notify users” may be augmented by the alternative terminology of “Email” associated to a given command such as “Email Users” to send an email to users to notify them. The DSL conditional operators 238 may include various conditional operators, such as an “If”, “Else”, and “Then” conditional operator, applied in rephrasing specified requirements with actions based on satisfying a condition into structured unambiguous automation steps of DSL formatted requirement statements with DSL conditional operators. For example, the specified requirement of “Notify users with a plus account that they have free shipping” which appears in requirements documents is rephrased into structured unambiguous automation steps of DSL formatted requirement statements with DSL conditional operators as “IF the user has a plus account, Then notify the user of free shipping.”

Storage 222 may additionally store DSL requirements 240 in files specifying structured unambiguous automation steps of DSL formatted requirement statements and RPA template 242 in files, for instance as YAML file format, including RPA code 244 for an automation. In embodiments, those skilled in the art should appreciate that different integrated development environment tools may employ various file formats for RPA code including templates, scripts or other types of files such as batch or bat files or python files to name a few.

In accordance with aspects of the invention, the environment 205 of FIG. 2 also shows user device 248 which may be a computer system such as end user device 103, described with respect to FIG. 1, that may communicate over WAN 246 which may be a wide area network such as WAN 102, described with respect to FIG. 1. User device 248 may include integrated development environment (IDE) tools 250 that provide a software development environment among other software development tools for a software developer. The IDE tools 250 may be used to generate RPA code such as RPA code 244 which may be any programming language source code including Java, JavaScript, Python, C++, C #, Visual Basic, SQL, PHP, or other programming language. RPA code may be written in various file formats, such as templates or scripts, using different integrated development environment tools that are built into deployable images and deployed in the production environment.

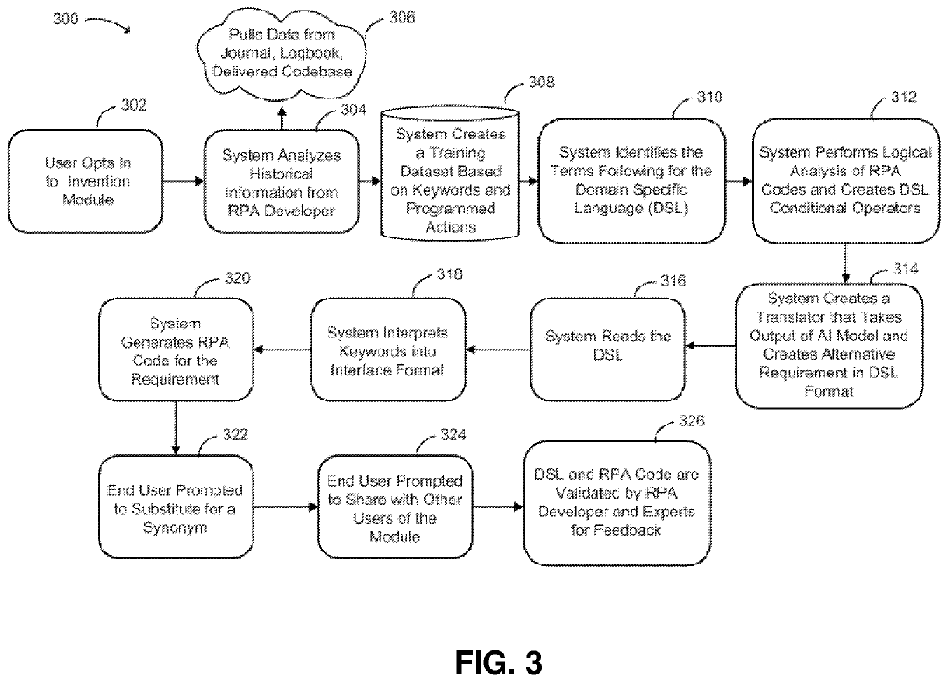

FIG. 3 depicts an illustration of an exemplary process flow diagram in accordance with aspects of the invention. The process flow diagram of FIG. 3 illustrates the process flow environment 300 in embodiments for automation of RPA bots in an automation development pipeline that generates automation DSL requirements from process automation requirements and generates the RPA bot from the automation DSL requirements. At reference numeral 302, the user of the present invention, for instance the RPA developer, opts in to use the exemplary modules of the present invention, such as automation DSL module 210, DSL translator module 214, and automation generator module 216, each described with respect to FIG. 2, accessed in an integrated development environment (IDE). The system of the present invention analyzes historical information from the RPA developer at 304 comprising data pulled from journals, logbooks and delivered codebases at 306. In embodiments, the data from journals, logbooks, and delivered codebases may additionally include a corpus of requirements documents 224, journals 226, logbooks 228, delivered codebases 230, and various automation DSL requirements 240, each described with respect to FIG. 2, from earlier or similar automation projects.

The system creates the training dataset in embodiments based on keywords and programmed actions at reference numeral 308 from the historical information. The AI model is trained using the training dataset to identify DSL terms and generate DSL conditional operators for translation into DSL requirements. The system accordingly identifies terms for the DSL at 310 from keywords in the requirements documents and generates DSL terms by augmenting those keywords with alternative or supplemental terminology that includes an alternative reference, search names or an association to given commands. For instance, the term “Notify” in the requirement to “Notify users” in the requirements document is identified as a term for the DSL and is augmented in DSL requirements with the alternative terminology of “Email” to generate the DSL term of “Notify (Email).” The system further performs logical analysis of RPA codes at 312 and creates DSL conditional operators. The logical analysis identifies conditions in the requirements of the requirements document for taking action in the documented process flow and rephrases those specified requirements into structured unambiguous automation steps of DSL formatted requirement statements with DSL conditional operators. For example, the specified requirement of “Notify users with a plus account that they have free shipping” which appears in requirements documents is rephrased into structured unambiguous automation steps of DSL formatted requirement statements with DSL conditional operators as “IF the user has a plus account, Then notify (email) the user of free shipping.”

The system creates a translator that takes the output of the AI model and creates alternative requirements in DSL format at reference numeral 314. For instance, DSL requirements are created using the DSL terms and DSL conditional operators generated from the requirements document. The system reads the DSL requirements at 316 and interprets keywords of the DSL requirements into the interface format, for instance of an IDE, at 318 using the augmented terminology of an alternative reference, search names or an association to given commands. The system then generates RPA code for the DSL requirement at 320. A machine learning model is trained using the training dataset to generate RPA code for the DSL requirements. For example, the DSL requirement with the DSL term “Notify (Email)” read from DSL requirements to “Notify (Email) users” is associated with the RPA code for sending email to the users and the RPA code for sending email to the users is generated. The system displays the RPA code generated for the DSL requirement in the IDE used by the user.

Upon generating the RPA code for the DSL requirement, the system prompts the user at reference numeral 322 to substitute a synonym for the keyword in the DSL terms which may be associated with different RPA code that satisfies the DSL requirement if the RPA code generated does not meet the DSL requirement. The system can then generate the RPA code for the synonym that may meet the DSL requirement. The system further prompts the user for their permission to share the synonym with other users of the module at 324. With the user's permission, the synonym can be displayed as a suggested in a pop-up window to other users that opt in to use the exemplary modules of the present invention. At 326, the automation DSL requirements and RPA code are validated by the RPA developer and experts for feedback. The feedback can be used to improve the RPA code if needed. In embodiments, the feedback may also be used to improve the training dataset, the AI model, and the machine learning model. The validated RPA code can be built into a deployable image of the automation and the automation can be deployed in the production environment.

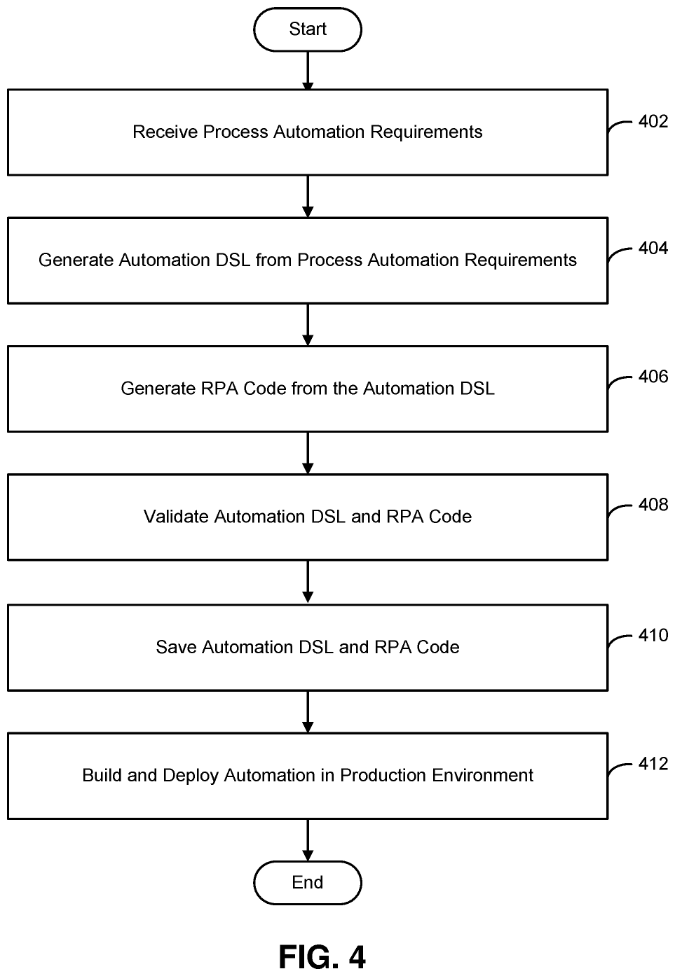

FIGS. 4-6 show flowcharts and/or block diagrams that illustrate the architecture, functionality, and operation of possible implementations of systems, methods, and computer program products according to various embodiments of the present invention. As noted above with respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time. And some blocks shown may be performed and other blocks not performed, depending upon the functionality involved.

FIG. 4 shows a flowchart of an exemplary method in accordance with aspects of the present invention. Steps of the method may be carried out in the environment of FIG. 2 and are described with reference to elements depicted in FIG. 2. In particular, the flowchart of FIG. 4 shows an exemplary method for automation of generating a robotic process automation bot from an automation domain specific language in accordance with aspects of the present invention.

At step 402, the system receives process automation requirements. For example, the process automation requirements can be any type of specification of process automation requirements documenting a process flow, such as a process definition document (PDD), a BPMN2.0 diagram, or other type of specification including an audio file of spoken process automation requirements. The process automation requirements may include the process flow and sequence of steps for the current manual process as well as the automated process, and the various exceptions, conditions and rules of the process to be automated. In embodiments, and as described with respect to FIG. 2, the automation DSL module 210 receives process automation requirements such as requirements documents 224.

At step 404, the system generates automation DSL from the process automation requirements. For example, the system identifies DSL terms in embodiments from keywords in the process automation requirements and augments keywords with alternative or supplemental terminology that includes an alternative reference, search names or an association to given commands or programmed actions. The system performs logical analysis of RPA codes in embodiments to identify conditions in the requirements for taking action and rephrases those requirements into structured unambiguous automation steps of DSL formatted requirement statements with DSL conditional operators. The system creates alternative requirements in DSL format using the DSL terms augmented with supplemental terminology and requirement statements formatted with DSL conditional operators for automation DSL requirements. In embodiments, and as described with respect to FIG. 2, the automation DSL module 210 generates DSL terms 236 and DSL conditional operators 238 for translation into DSL requirements 240 from process automation requirements such as requirements documents 224 using AI model 212 and the DSL translator module 214 translates the DSL terms 236 and DSL conditional operators 238 into structured unambiguous automation steps of automation DSL requirements 240.

At step 406, the system generates RPA code from the automation DSL requirements. For instance, the system reads each DSL requirement from the automation DSL requirements in embodiments, interprets the keyword of the DSL requirement using the augmented terminology into the interface for insertion into the RPA template or script, generates RPA code for the requirement from a machine learning model trained to generates RPA code that fulfills the DSL requirement, and inserts the RPA code into the RPA template or script. In embodiments, and as described with respect to FIG. 2, the automation generator module 216 generates RPA code 244 from the automation DSL requirements 240 employing machine learning model 218.

At step 408, the user validates the automation DSL requirements and the RPA code. For example, the RPA developer reviews each DSL requirement and the RPA code generated for the requirement in embodiments. If the RPA developer determines a DSL requirement does not meet the requirement from the process automation requirements, the RPA developer can edit the DSL requirement using the IDE tools and regenerate the RPA code. If the RPA developer determines the RPA code does not meet the requirement from the process automation requirements, the RPA developer can substitute a synonym for the keyword in the DSL terms which may be associated with different RPA code that satisfies the DSL requirement and the system can then regenerate the RPA code for the synonym. Alternatively, the RPA developer can edit the RPA code using the IDE tools to generate the RPA code that meets the DSL requirement. In embodiments, and as described with respect to FIG. 2, the user can validate the automation DSL requirements 240 and RPA code 244 using IDE tool 250 on the user device 248.

At step 410, the system saves the automation DSL requirements and the RPA code. For example, the RPA developer can select saving the DSL requirements and can select saving the RPA code from a drop-down menu in the IDE tools executing on the user device. In embodiments, and as described with respect to FIG. 2, the server 206 may receive an indication from the user device 248 to save the automation DSL requirements 240 and the RPA code 244 and save the automation DSL requirements 240 and the RPA code 244 in storage 222.

At step 412, the system builds and deploys the automation in the production environment. The validated RPA code 244 can be built into a deployable image of the automation, such as RPA bot 220 described with respect to FIG. 2, and the automation can be deployed in the production environment. In this way, the present invention generates templated commands in automation of RPA bots from terminology in process design documents and assists RPA developers by generating an initial version of the RPA bot using the generated templated commands.

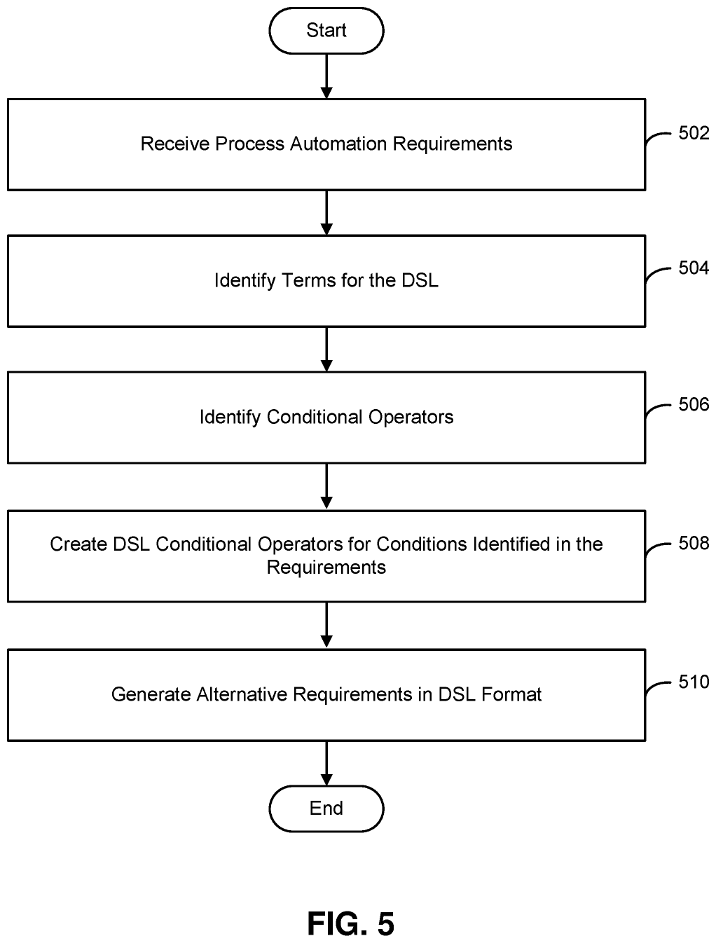

FIG. 5 shows a flowchart of an exemplary method in accordance with aspects of the present invention. Steps of the method may be carried out in the environment of FIG. 2 and are described with reference to elements depicted in FIG. 2. In particular, the flowchart of FIG. 5 shows an exemplary method for generating automation DSL from the process automation requirements, in accordance with aspects of the present invention.

At step 502, the system receives process automation requirements. For example, the process automation requirements can be any type of specification of process automation requirements documenting a process flow, such as a process definition document (PDD), a BPMN2.0 diagram, or other type of specification including an audio file of spoken process automation requirements. The process automation requirements may include the process flow and sequence of steps for the current manual process as well as the automated process, and the various exceptions, conditions and rules of the process to be automated. In embodiments, and as described with respect to FIG. 2, the automation DSL module 210 receives process automation requirements such as requirements documents 224.

At step 504, the system identifies terms for the automation DSL requirements. For example, the system identifies DSL terms in embodiments from keywords in the process automation requirements using the AI model. In embodiments, the AI model may be a text classification model using a naïve bayes algorithm that is trained using the training dataset to identify DSL terms in the requirements by comparing features, including keywords, extracted from text in the requirements with features of DSL terms learned in the text classification model. Other text classification algorithms may be used in embodiments to identify DSL terms, for example, support vector machines, or cosine similarity may be used by the text classification model. In embodiments, the text classification model identifies supplemental terminology, including an alternative reference, search names or an association to given commands, of keywords associated with keywords and programmed actions or commands used in the development of previous versions of RPA bots. The system accordingly identifies terms for the DSL from keywords in the requirements documents and generates DSL terms by augmenting those keywords with alternative or supplemental terminology that includes an alternative reference, search names or an association to given commands. For instance, the term “Notify” in the requirement to “Notify users” in the requirements document is identified as a term for the DSL and is augmented in DSL requirements with the alternative terminology of “Email” to generate the DSL term of “Notify (Email).” In embodiments, and as described with respect to FIG. 2, the automation DSL module 210 generates DSL terms 236 for translation into DSL requirements 240 from process automation requirements such as requirements documents 224 using AI model 212.

At step 506, the system identifies conditional operators for the automation DSL requirements. For instance, the system performs logical analysis of RPA codes in embodiments to identify conditions in the requirements for taking action using the AI model. In embodiments, the AI model may be a text classification model using a naïve bayes algorithm that is trained using the training dataset to identify conditions in the requirements by comparing features extracted from text in the requirements with features of DSL conditions learned in the text classification model. Other text classification algorithms may be used in embodiments to identify DSL conditions, for example, support vector machines may be used by the text classification model. As an example, the specified requirement of “Notify users with a plus account that they have free shipping” which appears in requirements documents is identified as having the condition of “with a plus account” for taking action to “notify users that they have free shipping”. In embodiments, and as described with respect to FIG. 2, the automation DSL module 210 generates DSL conditional operators 238 for translation into DSL requirements 240 from process automation requirements such as requirements documents 224 using AI model 212.

At step 508, the system creates DSL conditional operators for conditions identified in the requirements. For instance, the system rephrases those requirements with a condition for taking action into structured unambiguous automation steps of DSL formatted requirement statements with DSL conditional operators, such as “If”, “Else”, and “Then” conditional operators. Continuing with the example above, the specified requirement of “Notify users with a plus account that they have free shipping” which appears in requirements documents is rephrased into structured unambiguous automation steps of DSL formatted requirement statements with DSL conditional operators as “IF the user has a plus account, Then notify (email) the user of free shipping.” In embodiments, and as described with respect to FIG. 2, the automation DSL module 210 generates DSL conditional operators 238 for translation into DSL requirements 240 from process automation requirements such as requirements documents 224 using AI model 212.

At step 510, the system generates alternative requirements in DSL format. For example, the system creates alternative requirements in DSL format using the DSL terms augmented with supplemental terminology and using the requirement statements formatted with DSL conditional operators for automation DSL requirements. In embodiments, and as described with respect to FIG. 2, the DSL translator module 214 translates the DSL terms 236 and DSL conditional operators 238 into structured unambiguous automation steps of automation DSL requirements 240.

Those skilled in the art should appreciate that in addition to identifying conditional logical operations in the requirements, other types of logical operations including comparison logical operations, boolean logical operations, and identity logical operations may be identified in the requirements and the requirements may be rephrased using applicable DSL logical operators. For instance, a comparison logical operation may be identified in a requirement and DSL comparison operators such as Equal, Not Equal, Greater Than, Less Than, and so forth, may be used to rephrase the requirement making the comparison for taking action into structured unambiguous automation steps of automation DSL requirements.

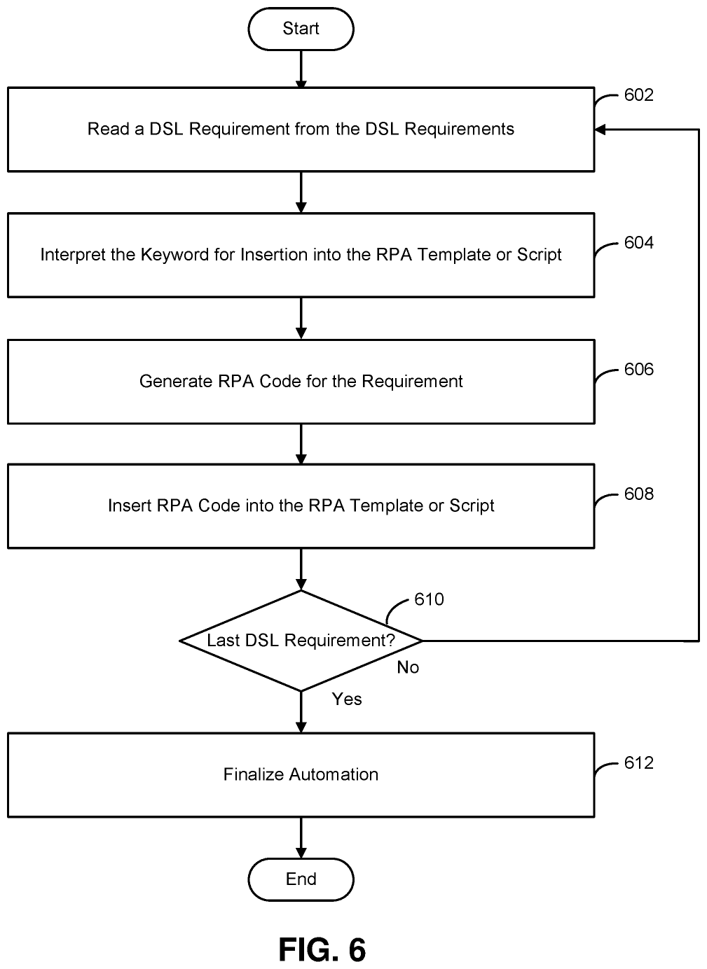

FIG. 6 shows a flowchart of an exemplary method in accordance with aspects of the present invention. Steps of the method may be carried out in the environment of FIG. 2 and are described with reference to elements depicted in FIG. 2. In particular, the flowchart of FIG. 6 shows an exemplary method for generating RPA code from automation DSL requirements, in accordance with aspects of the present invention.

At step 602, the system reads a DSL requirement from the automation DSL requirements, and, at step 604, the system interprets the keyword of the DSL requirement using the augmented terminology for insertion into the RPA template or script. The IDE tool on the user device displays the keyword in embodiments with the augmented terminology. In embodiments, and as described with respect to FIG. 2, the automation generator module 216 reads a DSL requirement from the automation DSL requirements 240 and interprets the keyword of the DSL requirement using the augmented terminology for insertion into the RPA template 242 or script.

At step 606, the system generates RPA code for the DSL requirement. For example, the system generates RPA code for the requirement from a machine learning model trained to generates RPA code that fulfills the DSL requirement. In embodiments, the machine learning model identifies the RPA code using a Long Short Term Memory (LSTM) algorithm trained with features of process automation requirements and RPA code associated with the features of the process automation requirements from training data of robotic process automation projects. In embodiments, and as described with respect to FIG. 2, the automation generator module 216 generates RPA code 244 for the DSL requirement using machine learning model 218. Those skilled in the art should appreciate that other Recurring Neural Network algorithms may be used by the machine learning model, including gated recurring unit (GRU) to generate RPA code.

At step 608, the system inserts the RPA code into the RPA template or script. For instance, the keyword of the DSL and the command or programmed action are inserted via an interface with the editor of the IDE in the appropriate section of the structured RPA template or script by the editor of the IDE displaying the RPA template or script. In embodiments, and as described with respect to FIG. 2, the automation generator module 216 inserts the RPA code 244 in the RPA template 242 or script.

At step 610, the system determines whether the last DSL requirement was read from the automation DSL requirements. If not, carrying out steps of the exemplary method continue at step 602. If the last DSL requirement was read from the automation DSL requirements, carrying out steps of the exemplary method continue at step 612. In embodiments, and as described with respect to FIG. 2, the automation generator module 216 determines whether the last DSL requirement was read from the automation DSL requirements 240.

At step 612, the system finalizes the automation. In embodiments, and as described with respect to FIG. 2, the automation generator module 216 finalizes the automation. The RPA code can be validated by the RPA developer and feedback provided by the RPA developer can be used to improve the RPA code if needed. The validated RPA code can be built into a deployable image of the automation and the automation can be deployed in the production environment.

In this way, embodiments of the present disclosure may assist an RPA developer in generating an initial version of an RPA bot from process requirement documents. Using a historical corpus of various information from RPA projects, the AI model converts process automation requirements into structured unambiguous automation steps of DSL requirements. Automation generator modules employing a machine learning model can generate RPA code for the steps of the DSL requirements to facilitate automation of generating an RPA bot. Advantageously, RPA developer feedback can be used to improve the training dataset, the AI model, and the machine learning model.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by a processor set, process automation requirements specifying a process flow;
generating, by the processor set, alternative automation requirements in a domain specific language from terms of the domain specific language identified in the process automation requirements;
generating, by the processor set, robotic process automation code from the alternative automation requirements in the domain specific language;
building, by the processor set, a robotic process automation robot deployable in a production environment using the robotic process automation code; and
deploying, by the processor set, the robotic process automation robot in the production environment.

2. The method of claim 1, further comprising identifying, by the processor set, the terms of the domain specific language from the process automation requirements using an artificial intelligence model trained to identify the terms of the domain specific language by comparing features extracted from text in the process automation requirements with features of terms extracted from text in a corpus of training data from robotic process automation projects.

3. The method of claim 1, further comprising:
identifying, by the processor set, requirements in the process automation requirements with actions based on satisfying conditions for performing the actions expressed in the process automation requirements using an artificial intelligence model trained to identify the conditions expressed for performing the actions in the process automation requirements by comparing features extracted from text in the process automation requirements with features extracted from text specifying other actions based on satisfying other conditions for performing the other actions expressed in a corpus of training data from robotic process automation projects; and
creating conditional operators in the domain specific language for the identified requirements with the actions based on satisfying the conditions for performing the actions expressed in the process automation requirements.

4. The method of claim 1, further comprising generating, by the processor set, alternative automation requirements in the domain specific language with conditional operators for requirements in the process automation requirements with actions based on satisfying conditions for performing the actions expressed in the process automation requirements.

5. The method of claim 1, further comprising identifying, by the processor set, the robotic process automation code from the alternative automation requirements in the domain specific language using a machine learning model employing a Long Short Term Memory (LSTM) algorithm trained with features of a plurality of process automation requirements and a plurality of robotic process automation code associated with the features of the plurality of process automation requirements from training data of robotic process automation projects.

6. The method of claim 1, further comprising appending, by the processor set, to keywords from the process automation requirements supplemental terminology selected from the group consisting of an alternative reference, search names, and an association to commands.

7. The method of claim 1, further comprising storing, by the processor set, the alternative automation requirements in the domain specific language in persistent storage.

8. The method of claim 1, further comprising storing, by the processor set, the robotic process automation code in persistent storage.

9. The method of claim 1, further comprising inserting, by the processor set, the generated robotic process automation code into a robotic process automation template.

10. The method of claim 1, further comprising inserting, by the processor set, the generated robotic process automation code into a robotic process automation script.

11. The method of claim 1, wherein the process automation requirements are selected from the group consisting of a process definition document, a business process modeling notation diagram, and an audio file of spoken process automation requirements.

12. The method of claim 2, wherein the training data is based on keywords and programmed actions.

13. The method of claim 5, wherein the training data is based on keywords and programmed actions.

14. A computer program product comprising one or more computer readable storage media having program instructions collectively stored on the one or more computer readable storage media, the program instructions executable to:
receive process automation requirements specifying a process flow;
generate alternative automation requirements in a domain specific language from terms of the domain specific language identified in the process automation requirements;
generate robotic process automation code from the alternative automation requirements in the domain specific language using a machine learning model trained with features of a plurality of robotic process automation code associated with features of a plurality of process automation requirements from training data of robotic process automation projects;
build a robotic process automation robot deployable in a production environment using the generated robotic process automation code; and
deploy the robotic process automation robot in the production environment.

15. The computer program product of claim 14, wherein the program instructions are further executable to create conditional operators in the domain specific language for requirements with actions based on satisfying conditions for performing the actions expressed in the requirements.

16. The computer program product of claim 14 wherein the program instructions are further executable to identify the terms of the domain specific language from the received process automation requirements using an artificial intelligence model trained to identify the terms of the domain specific language from a corpus of training data of robotic process automation projects.

17. A system comprising:
a processor set, one or more computer readable storage media, and program instructions collectively stored on the one or more computer readable storage media, the program instructions executable to:
receive process automation requirements specifying a process flow;
generate alternative automation requirements in a domain specific language from terms of the domain specific language identified in the process automation requirements using an artificial intelligence model trained to identify the terms of the domain specific language from a corpus of training data of robotic process automation projects;
generate robotic process automation code from the alternative automation requirements in the domain specific language;
build a robotic process automation robot deployable in a production environment using the robotic process automation code; and
deploy the robotic process automation robot in the production environment.

18. The system of claim 17, wherein the program instructions are further executable to create conditional operators in the domain specific language for requirements with actions based on satisfying conditions for performing the actions expressed in the requirements.

19. The system of claim 17, wherein the program instructions are further executable to identify the robotic process automation code from the alternative automation requirements in the domain specific language using a machine learning model employing a Long Short Term Memory (LSTM) algorithm trained with features of a plurality of process automation requirements and a plurality of robotic process automation code associated with the features of the plurality of process automation requirements from training data of robotic process automation projects.

20. The system of claim 17, wherein the program instructions are further executable to append to keywords from the process automation requirements supplemental terminology selected from the group consisting of an alternative reference, search names, and an association to commands.
